(19) United States
(12) Patent Application Publication
(10) Pub. No.: US 2017/0204232 A1
(43) Pub. Date: Jul. 20, 2017

(54) PREPARATION OF POLY ALPHA-1,3-GLUCAN ESTER FILMS

(71) Applicant: E. I. DU PONT DE NEMOURS AND COMPANY, Wilmington, DE (US)

(72) Inventor: Vindhya Mishra, Wilmington, DE (US)

(73) Assignee: E. I. DU Pont De Nemours and Company, Wilmington, DE (US)

(21) Appl. No.: 15/320,878

(22) PCT Filed: Jun. 25, 2015
(86) PCT No.: PCT/US2015/037634

§ 371 Date: Dec. 21, 2016

Related U.S. Application Data
(60) Provisional application No. 62/017,450, filed on Jun. 26, 2014.

(51) Int. Cl. C08J 5/18; C08B 37/00

(52) U.S. Cl. CPC C08J 5/18; C08B 37/0009; C08J 2305/00

(57) ABSTRACT

The present disclosure is directed toward an extrusion process for making a poly alpha-1,3-glucan ester film. These films can be translucent and used in packaging applications.

### CROSS-REFERENCE TO RELATED APPLICATION

This disclosure claims the benefit of priority of U.S. Provisional Application No. 62/017450, filed on Jun. 26, 2014, the entirety of which is herein incorporated by reference.

### FIELD OF INVENTION

This disclosure is in the field of poly alpha-1,3-glucan derivatives. Specifically, this disclosure pertains to a method of preparation of films and articles of poly alpha-1,3-glucan esters by extrusion.

### BACKGROUND

Driven by a desire to find new structural polysaccharides using enzymatic syntheses or genetic engineering of microorganisms or plant hosts, researchers have discovered polysaccharides that are biodegradable, and that can be made economically from renewable resource-based feedstocks. Cellulose is a typical example of such a polysaccharide and is comprised of beta-1,4-D-glycosidic linkages of hexopyranose units. Cellulose derivatives such as cellulose-acetates are used for several commercial applications such as in manufacture of films for LCD polarizers, labels, packaging etc. Cellulose for industrial applications is derived from wood pulp. Cellulose esters offer advantages of increased moisture stability compared to cellulose films or cellophane. Synthesis of cellulose derivatives is an expensive and difficult procedure. One such commonly used ester is cellulose acetate, made by the reaction of cellulose and acetic acid or acetic anhydride in presence of sulfuric acid. The reaction proceeds readily to achieve complete substitution of all hydroxyl groups to form esters, limiting the reaction to an intermediate degree of substitution is not possible practically form cellulose triacetate. However, cellulose triacetates have limited solubility, particularly at high degrees of acylation, and need a toxic chemical dichloromethane to achieve solubility. Cellulose mono and diacetates are soluble in a broader variety of solvents, however they cannot be synthesized directly. The synthesis of cellulose acetates involves synthesis of the cellulose triacetate, followed by hydrolysis of the triacetate to form acetates with reduced degree of substitution. This involves additional cost and processing. Thus, the industry is looking for alternatives to cellulose acetates that have similar or improved properties, with more controlled synthesis route.

A polysaccharide with characteristics similar to cellulose is poly alpha-1,3-glucan, a glucan polymer characterized by having alpha-1,3-glycosidic linkages. This polymer has been isolated by contacting an aqueous solution of sucrose with a glucosyltransferase enzyme isolated from Streptococcus salivarius (Simpson et al., Microbiology 141:1451-1460, 1995).

U.S. Pat. No. 7,000,000 disclosed the preparation of a polysaccharide fiber comprising hexose units, wherein at least 50% of the hexose units within the polymer were linked via alpha-1,3-glycosidic linkages using an S. salivarius gtfJ enzyme. This enzyme utilizes sucrose as a substrate in a polymerization reaction producing poly alpha-1,3-glucan and fructose as end-products (Simpson et al., 1995). The disclosed polymer formed a solution when it was dissolved in a solvent or in a mixture comprising a solvent. From this solution, continuous, strong, cotton-like fibers, highly suitable for use in textiles, were spun and used.

It would be desirable to make films composed of a polysaccharide glucan polymer without the drawbacks of cellulose based films.

### SUMMARY OF INVENTION

In a first embodiment, the disclosure concerns a process for making a poly alpha-1,3-glucan ester film comprising: (a) dissolving poly alpha-1,3-glucan ester in a solvent composition to provide a solution of poly alpha-1,3-glucan ester; (b) extruding the solution of poly alpha-1,3-glucan ester into a coagulation bath to make a film-shaped wet gel; (c) washing the film-shaped wet gel with a wash liquid; (d) optionally, plasticizing the film-shaped wet gel with a plasticizer additive; and (e) removing the wash liquid from the film-shaped wet gel to form a poly alpha-1,3-glucan ester film.

In a second embodiment, the disclosure concerns the poly alpha-1,3-glucan ester is poly alpha-1,3-glucan acetate.

In a third embodiment, the disclosure concerns the solvent composition further comprises a solubility additive, a plasticizer additive or a mixture thereof.

In a fourth embodiment, the disclosure concerns the solvent composition comprises formic acid.

In a fifth embodiment, the disclosure concerns the coagulation bath comprises a water bath.

In a sixth embodiment, the disclosure concerns the wash liquid comprises water.

In a seventh embodiment, the disclosure concerns the film-shaped wet gel has a breaking stress of at least about 1.5 MPa.

In an eight embodiment, the disclosure concerns a poly alpha-1,3-glucan ester film made according to a process comprising: (a) dissolving poly alpha-1,3-glucan ester in a solvent composition to provide a solution of poly alpha-1,3-glucan ester; (b) extruding the solution of poly alpha-1,3-glucan ester into a coagulation bath to make a film-shaped wet gel; (c) washing the film-shaped wet gel with a wash liquid; (d) optionally, plasticizing the film-shaped wet gel with a plasticizer additive; and (e) removing the wash liquid from the film-shaped wet gel to form a poly alpha-1,3-glucan ester film.

In a ninth embodiment, the disclosure concerns a film comprising poly alpha-1,3-glucan ester.

In a tenth embodiment, the disclosure concerns the film has at least one of: (a) haze less than about 10%; or (b) breaking stress from about 10 to about 100 MPa.

### DETAILED DESCRIPTION OF INVENTION

The disclosures of all patent and non-patent literature cited herein are incorporated herein by reference in their entirety.

As used herein, the term “invention” or “disclosed invention” is not meant to be limiting, but applies generally to any of the inventions defined in the claims or described herein. These terms are used interchangeably herein. Unless otherwise disclosed, the terms “a” and “an” as used herein are intended to encompass one or more (i.e., at least one) of a referenced feature.

The term “film” used herein refers to a thin, visually continuous material.

The term “packaging film” used herein refers to a thin, visually continuous material partially or completely encompassing an object.

The term “film-shaped wet gel” used herein refers to the thin, visually continuous, coagulated form of the film-forming solution

The term “plasticizing” used herein refers the well-known effect of using an additive to achieve softening which involves (a) lowering of rigidity at room temperature; (b) lowering of temperature, at which substantial deformations can be effected with not too large forces; (c) increase of the elongation to break at room temperature;

The term “solvent composition” used herein refers to the mixture of compounds that are needed to dissolve the polymer

The terms “poly alpha-1,3-glucan”, “alpha-1,3-glucan polymer” and “glucan polymer” are used interchangeably herein. Poly alpha-1,3-glucan is a polymer comprising glucose monomeric units linked together by glycosidic linkages, wherein at least about 50% of the glycosidic linkages are alpha-1,3-glycosidic linkages. Poly alpha-1,3-glucan is a type of polysaccharide. The structure of poly alpha-1,3-glucan can be illustrated as follows:

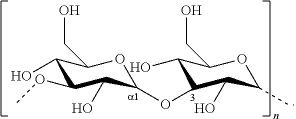

The poly alpha-1,3-glucan that can be used for preparing poly alpha-1,3-glucan ester compounds can be prepared using chemical methods. Alternatively, it can be prepared by extracting it from various organisms, such as fungi, that produce poly alpha-1,3-glucan. Alternatively still, poly alpha-1,3-glucan can be enzymatically produced from sucrose using one or more glucosyltransferase (gtf) enzymes (e.g., gtfJ), such as described in U.S. Pat. No. 7,000,000, and U.S. Patent Appl. Publ. Nos. 2013/0244288 and 2013/0244287 (all of which are incorporated herein by reference), for example.

The terms “glucosyltransferase enzyme”, “gtf enzyme”, “gtf enzyme catalyst”, “gtf”, and “glucansucrase” are used interchangeably herein. The activity of a gtf enzyme herein catalyzes the reaction of sucrose substrate to make products poly alpha-1,3-glucan and fructose. Other products (byproducts) of a gtf reaction can include glucose (where glucose is hydrolyzed from the glucosyl-gtf enzyme intermediate complex), various soluble oligosaccharides (DP2-DP7), and leucrose (where glucose of the glucosyl-gtf enzyme intermediate complex is linked to fructose). Leucrose is a disaccharide composed of glucose and fructose linked by an alpha-1,5 linkage. Wild type forms of glucosyltransferase enzymes generally contain (in the N-terminal to C-terminal direction) a signal peptide, a variable domain, a catalytic domain, and a glucan-binding domain. A gtf herein is classified under the glycoside hydrolase family 70 (GH70) according to the CAZy (Carbohydrate-Active EnZymes) database (Cantarel et al., Nucleic Acids Res. 37:D233-238, 2009).

The percentage of glycosidic linkages between the glucose monomer units of poly alpha-1,3-glucan used to prepare poly alpha-1,3-glucan ester compounds herein that are alpha-1,3 is at least about 50%, 60%, 70%, 80%, 90%, 95%, 96%, 97%, 98%, 99%, or 100% (or any integer value between 50% and 100%). In such embodiments, accordingly, poly alpha-1,3-glucan has less than about 50%, 40%, 30%, 20%, 10%, 5%, 4%, 3%, 2%, 1%, or 0% (or any integer value between 0% and 50%) of glycosidic linkages that are not alpha-1,3.

Poly alpha-1,3-glucan used to produce poly alpha-1,3-glucan ester compounds herein is preferably linear/unbranched. In certain embodiments, poly alpha-1,3-glucan has no branch points or less than about 10%, 9%, 8%, 7%, 6%, 5%, 4%, 3%, 2%, or 1% branch points as a percent of the glycosidic linkages in the polymer. Examples of branch points include alpha-1,6 branch points, such as those present in mutan polymer.

The terms “glycosidic linkage” and “glycosidic bond” are used interchangeably herein and refer to the type of covalent bond that joins a carbohydrate (sugar) molecule to another group such as another carbohydrate. The term “alpha-1,3-glycosidic linkage” as used herein refers to the type of covalent bond that joins alpha-D-glucose molecules to each other through carbons 1 and 3 on adjacent alpha-D-glucose rings. This linkage is illustrated in the poly alpha-1,3-glucan structure provided above. Herein, “alpha-D-glucose” is referred to as “glucose”.

The terms “poly alpha-1,3-glucan ester compound”, “poly alpha-1,3-glucan ester”, and “poly alpha-1,3-glucan ester derivative” are used interchangeably herein. Embodiments of the disclosed invention concern a film comprising a poly alpha-1,3-glucan ester compound represented by the structure:

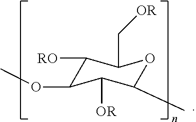

Regarding the formula of this structure, n can be at least 6, and each R can independently be a hydrogen atom (H) or an acyl group of the form —CO—R′ where R′ is CₘH₂ₘ₊₁, where m is greater than or equal to 0. An “acyl group” group herein can be an acetyl group (—CO—CH₃), propionyl group (—CO—CH₂—CH₃), butyryl group (—CO—CH₂—CH₂—CH₃), pentanoyl group (—CO—CH₂—CH₂—CH₂—CH₃), hexanoyl group (—CO—CH₂—CH₂—CH₂—CH₂—CH₃), heptanoyl group (—CO—CH₂—CH₂—CH₂—CH₂—CH₂—CH₃), or octanoyl group (—CO—CH₂—CH₂—CH₂—CH₂—CH₂—CH₂—CH₃), for example. The carbonyl group (—CO—) of the acyl group is ester-linked to carbon 2, 4, or 6 of a glucose monomeric unit of a poly alpha-1,3-glucan ester compound. . A poly alpha-1,3-glucan ester compound herein has a degree of substitution of about 0.05 to about 3.0.

Poly alpha-1,3-glucan ester compounds disclosed herein are synthetic, man-made compounds.

Regarding nomenclature, a poly alpha-1,3-glucan ester compound can be referenced herein by referring to the organic acid(s) corresponding with the acyl group(s) in the compound. For example, an ester compound comprising acetyl groups can be referred to as a poly alpha-1,3-glucan acetate, an ester compound comprising propionyl groups can be referred to as a poly alpha-1,3-glucan propionate, and an ester compound comprising butyryl groups can be referred to as a poly alpha-1,3-glucan butyrate. However, this nomenclature is not meant to refer to the poly alpha-1,3-glucan ester compounds herein as acids per se.

The terms “poly alpha-1,3-glucan monoester” and “monoester” are used interchangeably herein. A poly alpha-1,3-glucan monoester contains only one type of acyl group. Examples of such monoesters are poly alpha-1,3-glucan acetate (comprises acetyl groups) and poly alpha-1,3-glucan propionate (comprises propionyl groups).

The terms “poly alpha-1,3-glucan mixed ester” and “mixed ester” are used interchangeably herein. A poly alpha-1,3-glucan mixed ester contains two or more types of an acyl group. Examples of such mixed esters are poly alpha-1,3-glucan acetate propionate (comprises acetyl and propionyl groups) and poly alpha-1,3-glucan acetate butyrate (comprises acetyl and butyryl groups).

The term “degree of substitution” (DoS) as used herein refers to the average number of hydroxyl groups substituted in each monomeric unit (glucose) of a poly alpha-1,3-glucan ester compound. Since there are three hydroxyl groups in each monomeric unit in poly alpha-1,3-glucan, the DoS in a poly alpha-1,3-glucan ester compound herein can be no higher than 3. “Poly alpha-1,3-glucan triacetate” herein refers to a poly alpha-1,3-glucan ester compound with a degree of substitution by acetyl groups of 2.75 or higher

The “molecular weight” of poly alpha-1,3-glucan and poly alpha-1,3-glucan ester compounds herein can be represented as number-average molecular weight (Mₙ) or as weight-average molecular weight (M_{w}). Alternatively, molecular weight can be represented as Daltons, grams/mole, DPw (weight average degree of polymerization), or DPn (number average degree of polymerization). Various means are known in the art for calculating these molecular weight measurements, such as high-pressure liquid chromatography (HPLC), size exclusion chromatography (SEC), or gel permeation chromatography (GPC).

The terms “percent by weight”, “weight percentage (wt %)” and “weight-weight percentage (% w/w)” are used interchangeably herein. Percent by weight refers to the percentage of a material on a mass basis as it is comprised in a composition, mixture or solution.

Poly alpha-1,3-glucan ester compounds in certain embodiments disclosed herein may contain one type of acyl group. For example, one or more R groups ester-linked to the glucose group in the above formula may be a propionyl group; the R groups in this particular example would thus independently be hydrogen and propionyl groups. As another example, one or more R groups ester-linked to the glucose group in the above formula may be an acetyl group; the R groups in this particular example would thus independently be hydrogen and acetyl groups. Certain embodiments of poly alpha-1,3-glucan ester compounds herein do not have a DoS by acetyl groups of 2.75 or more.

Alternatively, poly alpha-1,3-glucan ester compounds disclosed herein can contain two or more different types of acyl groups. Examples of such compounds contain two different acyl groups, such as (i) acetyl and propionyl groups (poly alpha-1,3-glucan acetate propionate, where R groups are independently H, acetyl, or propionyl), or (ii) acetyl and butyryl groups (poly alpha-1,3-glucan acetate butyrate, where R groups are independently H, acetyl, or butyryl).

The poly alpha-1,3-glucan ester compound has a degree of substitution (DoS) of about 0.05 to about 3.0. Alternatively, the DoS of a poly alpha-1,3-glucan ester compound disclosed herein can be about 0.2 to about 2.0. Alternatively still, the DoS can be at least about 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0. It would be understood by those skilled in the art that since a poly alpha-1,3-glucan ester compound disclosed herein has a degree of substitution between about 0.05 to about 3.0, the R groups of the compound cannot only be hydrogen.

The wt % of one or more acyl groups in a poly alpha-1,3-glucan ester compound herein can be referred to instead of referencing a DoS value. For example, the wt % of an acyl group in a poly alpha-1,3-glucan ester compound can be at least about 0.1%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, or 60%.

The percentage of glycosidic linkages between the glucose monomer units of the poly alpha-1,3-glucan ester compound that are alpha-1,3 is at least about 50%, 60%, 70%, 80%, 90%, 95%, 96%, 97%, 98%, 99%, or 100% (or any integer between 50% and 100%). In such embodiments, accordingly, the compound has less than about 50%, 40%, 30%, 20%, 10%, 5%, 4%, 3%, 2%, 1%, or 0% (or any integer value between 0% and 50%) of glycosidic linkages that are not alpha-1,3.

The formula of a poly alpha-1,3-glucan ester compound in certain embodiments can have an n value of at least 6. Alternatively, n can have a value of at least 10, 50, 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, or 4000 (or any integer between 10 and 4000).

The molecular weight of a poly alpha-1,3-glucan ester compound disclosed herein can be measured as number-average molecular weight (Mₙ) or as weight-average molecular weight (M_{w}). Alternatively, molecular weight can be measured in Daltons or grams/mole. It may also be useful to refer to the DP_{w} (weight average degree of polymerization) or DPₙ (number average degree of polymerization) of the poly alpha-1,3-glucan polymer component of the compound.

The Mₙ or M_{w} of poly alpha-1,3-glucan ester compounds disclosed herein may be at least about 1000. Alternatively, the Mₙ or M_{w} can be at least about 1000 to about 600000. Alternatively still, the Mₙ or M_{w} can be at least about 10000, 25000, 50000, 75000, 100000, 125000, 150000, 175000, 200000, 225000, 250000, 275000, or 300000 (or any integer between 10000 and 300000), for example.

A poly alpha-1,3-glucan ester in certain embodiments can have a DoS by acetyl groups up to about 2.00, 2.05, 2.10, 2.15, 2.20, 2.25, 2.30, 2.35, 2.40, 2.45, 2.50, 2.55, 2.60, 2.65, 2.70, 2.75, 2.80, 2.85, 2.90, 2.95, or 3.00. Thus, for example, the DoS by acetyl groups can be up to about 2.00-2.40, 2.00-2.50, or 2.00-2.65. As other examples, the DoS by acetyl groups can be about 0.05 to about 2.60, about 0.05 to about 2.70, about 1.2 to about 2.60, or about 1.2 to about 2.70. Such poly alpha-1,3-glucan esters can be a monoester or a mixed ester.

A poly alpha-1,3-glucan ester in certain embodiments can have a wt % of propionyl groups up to about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, or 55%. Such poly alpha-1,3-glucan esters can be a monoester or a mixed ester. Regarding mixed esters, poly alpha-1,3-glucan acetate propionate can have a wt % of acetyl groups up to about 0.1%, 1%, 2%, 3%, 4%, 5%, 6%, 7%, 8%, 9%, or 10%, and a wt % of propionyl groups as per any of the propionyl wt %'s listed above, for example.

A poly alpha-1,3-glucan ester in certain embodiments can have a wt % of butyryl groups up to about 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, or 60%. A poly alpha-1,3-glucan ester in other embodiments can have a DoS by butyryl groups up to about 0.80, 0.85, 0.90, 0.95, 1.00, 1.05, 1.10, 1.15, or 1.20. Such poly alpha-1,3-glucan esters can be a monoester or a mixed ester. Regarding mixed esters, poly alpha-1,3-glucan acetate butyrate can have a wt % of acetyl groups up to about 0.1%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, or 36%, and a wt % of butyryl groups as per any of the butyryl wt %'s listed above, for example. 8.0).

The structure, molecular weight and DoS of a poly alpha-1,3-glucan ester product can be confirmed using various physiochemical analyses known in the art such as NMR spectroscopy and size exclusion chromatography (SEC).

The percentage of glycosidic linkages between the glucose monomer units of poly alpha-1,3-glucan used to prepare poly alpha-1,3-glucan ester compounds herein that are alpha-1,3 is at least about 50%, 60%, 70%, 80%, 90%, 95%, 96%, 97%, 98%, 99%, or 100% (or any integer value between 50% and 100%). In such embodiments, accordingly, poly alpha-1,3-glucan has less than about 50%, 40%, 30%, 20%, 10%, 5%, 4%, 3%, 2%, 1%, or 0% (or any integer value between 0% and 50%) of glycosidic linkages that are not alpha-1,3.

Poly alpha-1,3-glucan used to prepare poly alpha-1,3-glucan ester compounds herein is preferably linear/unbranched. In certain embodiments, poly alpha-1,3-glucan has no branch points or less than about 10%, 9%, 8%, 7%, 6%, 5%, 4%, 3%, 2%, or 1% branch points as a percent of the glycosidic linkages in the polymer. Examples of branch points include alpha-1,6 branch points.

The Mₙ or M_{w} of poly alpha-1,3-glucan used to prepare poly alpha-1,3-glucan ester compounds herein may be at least about 500 to about 300000. Alternatively still, Mₙ or M_{w} can be at least about 10000, 25000, 50000, 75000, 100000, 125000, 150000, 175000, 200000, 225000, 250000, 275000, or 300000 (or any integer between 10000 and 300000), for example.

A process according to the present disclosure for making a poly alpha-1,3-glucan ester film comprising: (a) dissolving poly alpha-1,3-glucan ester in a solvent composition to provide a solution of poly alpha-1,3-glucan ester; (b) extruding the solution of poly alpha-1,3-glucan ester into a coagulation bath to make a film-shaped wet gel; (c) washing the film-shaped wet gel with a wash liquid; (d) optionally, plasticizing the film-shaped wet gel with a plasticizer additive; and (e) removing the wash liquid from the film-shaped wet gel to form a poly alpha-1,3-glucan ester film.

The solution of poly alpha-1,3-glucan esters can be prepared by dissolving poly alpha-1,3-glucan ester in a solvent composition composed of one or more solvents, or a mixture of solvents and non-solvents. As used herein, the term “solution of poly alpha-1,3-glucan ester” refers to poly alpha-1,3-glucan ester dissolved in one or more solvent compositions.

The solvents useful for this purpose include, but are not limited to, methylene chloride (dichloromethane), methanol, chloroform, tetrachloroethane, formic acid, acetic acid, nitrobenzene, bromoform, pyridine, dioxane, ethanol, acetone, alcohols, dimethyl sulfoxide, dimethyl acetamide, aromatic compounds such as monochlorobenzene, benzene and toluene, esters such as ethyl acetate and propyl acetate, ethers such as tetrahydrofuran, methyl cellosolve and ethylene glycol monomethyl ether or combinations thereof. The solutions may also contain additives such as rheology modifiers, stabilizers, plasticizers etc. In an embodiment poly alpha-1,3-glucan acetate is dissolved in formic acid to prepare a solution of poly alpha-1,3-glucan acetate. This solution can then be extruded into a coagulation bath to form a film-shaped wet gel. The film-shaped wet gel has a breaking stress of at least about 1.5 MPa, preferably about 2.0 MPa and most preferably about 2.5 MPa. The solvent and coagulation components are then removed to form a film of desired thickness. Generally the coagulation components can be removed by washing with a wash liquid. Generally, the residual solvent composition can be removed by evaporation at room temperature or elevated temperature. It should be noted that depending on the solvent composition removal technique, some residual solvent composition or its' constituents may be present in small amounts. Using a similar process, films can also be made using solutions of other glucan esters such as solution of poly alpha-1,3-glucan formate in dimethyl sulfoxide. The films thus obtained are clear and transparent. They can have a glossy or a matte appearance. The haze and transmittance of the poly alpha-1,3-glucan ester film can be determined by methods well known in the art. As used herein, the term “haze” refers to the percentage of light that is deflected more than 2.5 degrees from the incoming light direction. Low haze values correspond to better clarity. The term “transmittance” as used herein, refers to the fraction of incident light at a specified wavelength that passes through a film.

The present disclosure is directed toward a process for making a poly alpha-1,3-glucan ester film comprising: (a) dissolving poly alpha-1,3-glucan ester in a solvent composition to provide a solution of poly alpha-1,3-glucan ester; (b) extruding the solution of poly alpha-1,3-glucan ester into a coagulation bath to make a film-shaped wet gel; (c) washing the film-shaped wet gel with a wash liquid; (d) optionally, plasticizing the film-shaped wet gel with a plasticizer additive; and (e) removing the wash liquid from the film-shaped wet gel to form a poly alpha-1,3-glucan ester film. The poly alpha-1,3-glucan ester can be poly alpha-1,3-glucan acetate. The solvent composition can further comprise a solubility additive, a plasticizer additive or a mixture thereof. The solvent composition can comprise formic acid. The coagulation bath can comprise a water bath. The wash liquid can comprise water. The film-shaped wet gel has a breaking stress of at least about 1.5 MPa.

The present disclosure is further directed toward a poly alpha-1,3-glucan ester film made according to a process comprising: (a) dissolving poly alpha-1,3-glucan ester in a solvent composition to provide a solution of poly alpha-1,3-glucan ester; (b) extruding the solution of poly alpha-1,3-glucan ester into a coagulation bath to make a film-shaped wet gel; (c) washing the film-shaped wet gel with a wash liquid; (d) optionally, plasticizing the film-shaped wet gel with a plasticizer additive; and (e) removing the wash liquid from the film-shaped wet gel to form a poly alpha-1,3-glucan ester film.

The present disclosure is still further directed toward a film comprising poly alpha-1,3-glucan ester. The film can have at least one of: (a) haze less than about 10%; or (b) breaking stress from about 10 to about 100 MPa.

### EXAMPLES

The present disclosure is further exemplified in the following Examples. It should be understood that these Examples, while indicating certain preferred aspects herein, are given by way of illustration only. From the above discussion and these Examples, one skilled in the art can ascertain the essential characteristics of the disclosed embodiments, and without departing from the spirit and scope thereof, can make various changes and modifications to adapt the disclosed embodiments to various uses and conditions.

### Abbreviations

“mL” is milliliter(s); “g” is gram(s); “DI water” is deionized water; “μL” is microliter(s); “° C.” is degrees Celsius; “mg” is milligram(s); “Hz” is Hertz; “MHz” is mega Hertz; “kgf” is kilogram force.

### GENERAL METHODS

### ¹H Nuclear Magnetic Resonance (NMR) Method for Determining Degree of Substitution of Poly Alpha-1,3-Glucan Acetate Derivatives

Degree of substitution (DoS) in poly alpha-1,3-glucan acetate ester derivatives was determined using ¹H NMR. Approximately 20 mg of derivative sample was weighed into a vial on an analytical balance. The vial was removed from the balance and 0.7 mL of TFA-d was added to the vial. A magnetic stir bar was added to the vial and the mixture was stirred until the solid sample dissolved. Deuterated benzene (C₆D₆), 0.3 mL, was then added to the vial to provide a better NMR lock signal than the TFA-d would provide. A portion, 0.8 mL, of the solution was transferred using a glass pipet into a 5-mm NMR tube. A quantitative ¹H NMR spectrum was acquired using an Agilent VNMRS 400 MHz NMR spectrometer equipped with a 5-mm Autoswitchable Quad probe. The spectrum was acquired at a spectral frequency of 399.945 MHz using a spectral window of 6410.3 Hz, an acquisition time of 1.278 seconds, and an inter-pulse delay of 10 seconds and 124 pulses. The time domain data were transformed using exponential multiplication of 0.78 Hz.

Two regions of the resulting spectrum were integrated: from 3.1 ppm to 6.0 ppm, giving the integral for the seven poly alpha-1,3-glucan protons, and from 1.4 ppm to 2.7 ppm, giving the integral for the three acetyl protons. The degree of acetylation was calculated by dividing one third of the acetyl protons integral area by one seventh of the poly alpha-1,3-glucan protons integral area.

### ¹H NMR Method for Determining Degree of Substitution of Poly Alpha-1,3-Glucan Propionate Derivatives

DoS in poly alpha-1,3-glucan propionate ester derivatives was determined using ¹H NMR. Approximately 20 mg of derivative sample was weighed into a vial on an analytical balance. The vial was removed from the balance and 0.7 mL of TFA-d was added to the vial. A magnetic stir bar was added to the vial and the mixture was stirred until the solid sample dissolved. Deuterated benzene (C₆D₆), 0.3 mL, was then added to the vial to provide a better NMR lock signal than the TFA-d would provide. A portion, 0.8 mL, of the solution was transferred using a glass pipet into a 5-mm NMR tube. A quantitative ¹H NMR spectrum was acquired using an Agilent VNMRS 400 MHz NMR spectrometer equipped with a 5-mm Autoswitchable Quad probe. The spectrum was acquired at a spectral frequency is 399.945 MHz using a spectral window of 6410.3 Hz, an acquisition time of 1.278 seconds, and an inter-pulse delay of 10 seconds and 32 pulses. The time domain data were transformed using exponential line broadening of 1.0 Hz and the benzene solvent peak was set to 7.15 ppm.

For poly alpha-1,3-glucan propionate samples, three regions of the resulting spectrum were integrated: from 3.3 ppm to 6.0 ppm, giving the integral for the seven poly alpha-1,3-glucan protons; from 1.9 ppm to 2.7 ppm, giving the integral for the methylene group of the propionyl group plus the methyl group of the acetyl group; and from 0.8 ppm to 1.3 ppm, giving the integral for the methyl group of the propionyl group.

The DoS by propionyl groups was calculated by dividing the integral value for the methyl group of the propionyl group by three. The integral value of the propionyl group's methylene group was then calculated by multiplying the integral value for the methyl group of the propionyl group by 0.666. This value was then subtracted from the integral for the region of the methylene group of the propionyl group plus the methyl group of the acetyl group to give the integral value for the acetyl group's methyl group.

### ¹H NMR Method for Determining Degree of Substitution of Poly Alpha-1,3-Glucan Mixed Ester Derivatives

DoS in poly alpha-1,3-glucan mixed ester derivatives was determined using ¹H NMR. Approximately 20 mg of derivative sample was weighed into a vial on an analytical balance. The vial was removed from the balance and 0.7 mL of TFA-d was added to the vial. A magnetic stir bar was added to the vial and the mixture was stirred until the solid sample dissolved. Deuterated benzene (C₆D₆), 0.3 mL, was then added to the vial to provide a better NMR lock signal than the TFA-d would provide. A portion, 0.8 mL, of the solution was transferred using a glass pipet into a 5-mm NMR tube. A quantitative ¹H NMR spectrum was acquired using an Agilent VNMRS 400 MHz NMR spectrometer equipped with a 5-mm Autoswitchable Quad probe. The spectrum was acquired at a spectral frequency of 399.945 MHz using a spectral window of 6410.3 Hz, an acquisition time of 1.278 seconds, and inter-pulse delay of 10 seconds and 32 pulses. The time domain data were transformed using exponential line broadening of 1.0 Hz and the benzene solvent peak was set to 7.15 ppm.

For poly alpha-1,3-glucan acetate propionate samples, three regions of the resulting spectrum were integrated: from 3.3 ppm to 6.0 ppm, giving the integral for the seven poly alpha-1,3-glucan protons; from 1.9 ppm to 2.7 ppm giving the integral for the methylene group of the propionyl group plus the methyl group of the acetyl group; and from 0.8 ppm to 1.3 ppm giving the integral for the methyl group of the propionyl group.

The DoS by propionyl groups on the glucan was calculated by dividing the integral value for the methyl group of the propionyl group by three. The integral value of the propionyl group's methylene group was then calculated by multiplying the integral value for the methyl group of the propionyl group by 0.666. This value was then subtracted from the integral for the region of the methylene group of the propionyl group plus the methyl group of the acetyl group to give the integral value for the acetyl group's methyl group. Finally, the acetyl group integral value was divided by three to obtain the degree of acetylation.

For poly alpha-1,3-glucan acetate butyrate samples, three regions of the resulting spectrum were integrated: from 3.3 ppm to 6.0 ppm giving the integral for the seven poly alpha-1,3-glucan protons; from 1.9 ppm to 2.6 ppm giving the integral for the methylene group alpha to the carbonyl of the butyryl group plus the methyl group of the acetyl group; and from 0.6 ppm to 1.0 ppm giving the integral for the methyl group of the butyryl group.

The DoS by butyryl groups on the glucan was calculated by dividing the integral value for the methyl group of the butyryl group by three. The integral value of the butyryl group's methylene group was then calculated by multiplying the integral value for the methyl group of the butyryl group by 0.666. This value was then subtracted from the integral for the region of the methylene group of the butyryl group plus the methyl group of the acetyl group to give the integral value for the acetyl group's methyl group. Finally, the acetyl group integral value was divided by three to obtain the degree of acetylation.

### Determination of the Degree of Polymerization and Molecular Weight

The degree of polymerization (DP), weight average molecular weight (Mw) and number average molecular weight (Mn) was determined by size exclusion chromatography (SEC). Poly alpha-1,3-glucan ester was dissolved in HFIP (2 mg/mL) with shaking for 4 hours at 45° C. The chromatographic system used was Alliance™ 2695 separation module from Waters Corporation (Milford, Mass.) coupled with three on-line detectors: a differential refractometer 2410 from Waters, a multi-angle light-scattering photometer Heleos™ 8+ from Wyatt Technologies (Santa Barbara, Calif.), and a differential capillary viscometer ViscoStar™ from Wyatt Technologies. The columns used for SEC were two Shodex (Showa Denko America, New York) GPC HFIP-806M™ styrene-divinyl benzene columns and one Shodex GPC HFIP-804M™ styrene-divinyl benzene column. The mobile phase was redistilled HFIP with 0.01 M sodium trifluoroacetate. Chromatographic conditions used were 50° C. at column and detector compartments, 40° C. at sample and injector compartments, a flow rate of 0.5 mL/min, and injection volume of 100 μL. Software packages used for data reduction were Astra version 6 from Wyatt (triple detection method with column calibration).

### Thickness

Thickness of the film was determined using a Mitutoyo micrometer, No. 293-831.

### Preparation for Tensile Testing

Dry Films were measured with a ruler and 1″×3″ strips were cut using a comfort loop rotary cutter by Fiskars, No. 195210-1001. The samples were then transported to the testing lab where room conditions were 65% relative humidity and 70° F. +/−2° F. The sample weight was measured using a Mettler balance model AE240.

Film-shaped wet gels were cut into samples 1 inch wide and at least 2 inch long. The samples were measured with a ruler and 1″×3″ strips were cut using a comfort loop rotary cutter by Fiskars, No. 195210-1001. The samples were then transported to the testing lab in a water bath where room conditions were 65% relative humidity and 70° F. +/−2° F. The wet sample weight was measured using a Mettler balance model AE240. The sample was left to soak in the water bath till right before testing.

### Tensile Properties

Tensile properties were measured on an Instron 5500R Model 1122, using 1″ grips, and a 1″ gauge length, in accordance with ASTM D882-09.

### Film Clarity

Film Clarity was determined using an Agilent (Varian) Cary 5000 uv/vis/nir spectrophotometer equipped with a DRA-2500 diffuse reflectance accessory in transmission mode. The DRA-2500 is a 150 mm integrating sphere with a Spectralon® coating. Total and diffuse transmission for the instrument and the samples are collected over the wavelength range of 830 nm to 360 nm. The calculations are made in accordance with ASTM D1003 using a 2 degree observer angle and illuminant C (represents average daylight, color temperature 6700K).

### Preparation of Poly Alpha-1,3-Glucan

Poly alpha-1,3-glucan, using a gtfJ enzyme preparation, was prepared as described in the co-pending, commonly owned U.S. Patent Application Publication Number 2013-0244288 which was published on Sep. 19, 2013, the disclosure of which is incorporated herein by reference.

### Preparation of Poly Alpha-1,3-Glucan Acetate

Poly alpha-1,3-glucan acetate was prepared as described in commonly owned U.S. Pat. No. 7,000,000, the disclosure of which is incorporated herein by reference.

### EXAMPLE

### Preparation of a Poly Alpha-1,3-Glucan Ester Film

15 g of glucan acetate (Mn=53020, Mw=135,300, degree of substitution=3.0) was mixed with 135 g of 98%+ formic acid (obtained from Sigma Aldrich (St. Louis, Mo.)). It was mixed in a 500 mL round bottom flask with overhead stirring for 1.5 hours. All particles dissolved to create a clear solution with a very slight yellow tint. The final glucan acetate concentration in the solution was 10%. The solution was centrifuged to remove air bubbles. The solution was spread onto a glass plate by pouring a controlled amount of solution onto a glass plate, and then drawn down using a Meyer rod. The solution and the plate were immediately immersed in a water bath until the film-shaped wet gel was formed. In most instances, the film-shaped wet gel removed itself from the glass. It should be noted that the solution of poly alpha-1,3-glucan acetate can be extruded directly into the coagulation bath via a slot die. The glass plate was used due to equipment limitations. However, the characteristics (strength, clarity) of the wet gel obtained by immediate coagulation of a film cast on a support are comparable to the characteristics of a wet gel obtained by extrusion into a coagulation bath. The film-shaped wet gel was then placed in a new water bath to wash off residual formic acid. This washing process was repeated until the pH of the bath remained neutral after the film was soaked for 10 minutes. The film-shaped wet gel was removed from the bath. This process produced a smooth, flat film-shaped wet gel with a thickness of 122 micron. The film-shaped wet gel was divided into two halves and tensile strength was measured on one-half. The tensile strength was found to be max strain of 35% and a breaking stress of 2.9 MPa. The film-shaped wet gel appeared colorless and transparent to the human eye while wet. The other half of remaining wet gel was allowed to air dry overnight and produced a clear film with a haze of 1.86%.

The same solution was used to generate another film-shaped wet gel of thickness 50 micron. The film-shaped wet gel was dried. The film thus formed was clear. Tensile strength of the dry film was measured. The tensile strength was found to be max strain of 4% and a breaking stress of ˜20 MPa.

Thus, a poly alpha-1,3-glucan ester film was made according to the present disclosure.

What is claimed is:

1. A process for making a poly alpha-1,3-glucan ester film comprising:
(a) dissolving poly alpha-1,3-glucan ester in a solvent composition to provide a solution of poly alpha-1,3-glucan ester;
(b) extruding the solution of poly alpha-1,3-glucan ester into a coagulation bath to make a film-shaped wet gel;
(c) washing the film-shaped wet gel with a wash liquid;
(d) optionally, plasticizing the film-shaped wet gel with a plasticizer additive; and
(e) removing the wash liquid from the film-shaped wet gel to form a poly alpha-1,3-glucan ester film. 15

2. The process according to claim 1, where the poly alpha-1,3-glucan ester is poly alpha-1,3-glucan acetate.

3. The process according to claim 1, wherein the solvent composition further comprises a solubility additive, a plasticizer additive or a mixture thereof.

4. The process according to claim 1, where the solvent composition comprises formic acid.

5. The process according to claim 1, wherein the coagulation bath comprises a water bath.

6. The process according to claim 1, wherein the wash liquid comprises water.

7. The process according to claim 1, wherein the film-shaped wet gel has a breaking stress of at least about 1.5 MPa.

8. A poly alpha-1,3-glucan ester film made according to claim 1.

9. A film comprising poly alpha-1,3-glucan ester.

10. The film according to claim 9, wherein the film has at least one of:
(a) haze less than about 10%; or
(b) breaking stress from about 10 to about 100 MPa.
